(19) United States
(12) Patent Application Publication
(10) Pub. No.: US 2019/0028294 A1
(43) Pub. Date: Jan. 24, 2019

(54) IMPROVEMENTS IN COMMUNICATION SYSTEMS FOR REMOTE DEVICE CONTROL

(71) Applicant: Carrier Corporation, Palm Beach Gardens, FL (US)

(72) Inventors: Gabriel Daher, Long Point, New South Wales (AU); Ron Johan, Queens Park, New South Wales (AU); Daniel Ming On Wu, Chatswood, New South Wales (AU)

(21) Appl. No.: 16/068,611

(22) PCT Filed: Dec. 23, 2016
(86) PCT No.: PCT/US2016/068508

§ 371 Date: Jul. 6, 2018

Related U.S. Application Data
(60) Provisional application No. 62/277,034, filed on Jan. 11, 2016.

(51) Int. Cl. H04L 12/28; H04L 29/08; H04W 4/029

(52) U.S. Cl. CPC H04L 12/2818; H04L 12/282; H04L 67/12; H04W 4/029; H04L 67/18

(57) ABSTRACT

A system, method, and devices for routing signals and controlling a home device are provided. The system includes a network including communication points that provide a path of communication between connected devices a home device that is connected using the network, a mobile device that is connected to the home device using the network, and a proprietary router in the network through which the mobile device is able to connect to the home device. The mobile device is configured to detect a triggering event at the mobile device, wherein the triggering event is associated with a control signal for controlling the home device, generate the control signal in response to the triggering event being detected, and transmit the control signal to the home device through the network using the proprietary router through the path of communication in response to the triggering event being detected.

### BACKGROUND

The present disclosure relates generally to improvements in communication systems and can be implemented in a number of mobile device applications, including, but not limited to remote device control when a triggering event is detected.

With the ready availability of mobile terminals such as smart telephones there is an increasing realization by users that security and home automation systems can be remotely controlled manually or controlled automatically. For example, a user can control a home security system to arm or disarm. This control command can be triggered by the proximity of the user to their premises as determined by the location of the user's mobile phone. The use of hysteresis to prevent retriggering at a wireless boundary such as at a geofence boundary or cell phone cell boundary can also be implemented.

A number of such systems have been disclosed which utilize one or more network-based servers to communicate with the user's mobile terminal to determine the user's location. For example, the server identifies that the mobile terminal has crossed one or more geographical boundary (geofence) and signals to the home security system or the home automation system to change state.

These systems have a number of concerns and possible short comings that may discourage their application by users. For example, privacy of the user and the user's information is a concern because, for example, the server may be aware of the user's every movement at all times. Security is also a concern because should the server be successfully breached by hackers, then the daily movements of all associated users will be available to the hackers and their associates as well as the users' stored information and possibly allow access and control of the users' devices. Reliability is also a concern because server-based systems generally operate with a centralized database. The use of a database to control message flows may introduce a potential single point of failure. This is because of the complex structure of database software and the interlinking of the database fields. Thus a traffic flow control operation involves a large number of computer operations (flops). This in turn slows the operation and increases the possibility of the occurrence of an error or signaling network malfunction. Further, response speed is a concern because servers operate a system of store-and-forward whereby every message received by the server is stored in the database and forwarded either to the customer terminal or to the mobile terminal. This increases system response times and leads to poor user experience especially as the number of users increases.

Additionally, households may be fitted with two or more systems, such as an alarm system and a home automation system, and the systems may have incompatible signaling or communication protocols requiring the user to utilize separate interfaces to, for example, arm the alarm system and turn off the heating system.

One or more embodiments as described herein set out to address one or more of the problems with the existing arrangements and implement a system which provides security and reliability and may further deliver a good user experience.

### SUMMARY

According to one embodiment, a mobile device for routing signals and controlling a home device is provided. The mobile device includes a computer readable storage medium having program instructions embodied therewith, the program instructions executable by a processor of the mobile device to cause the processor to detect a triggering event at the mobile device, wherein the triggering event is associated with a control signal for controlling the home device, generate the control signal in response to the triggering event being detected, and transmit the control signal from the mobile device to the home device through a network using a proprietary router associated with the home device in response to the triggering event being detected.

In addition to one or more of the features described above, or as an alternative, further embodiments of the mobile device may include additional program instructions executable by the processor of the mobile device to cause the processor to detect a crossing by the mobile device of a specified geofence based on geolocation capability and geofence detecting capability of the mobile device, and transmit a message to a terminal through the proprietary router in response to the detection of said crossing, wherein the proprietary router is adapted to establish a secure communication tunnel between the proprietary router and the terminal.

According to one embodiment, a method of routing signals and controlling a home device using a mobile device is provided. The method includes detecting a triggering event at the mobile device, wherein the triggering event is associated with a control signal for controlling the home device, generating the control signal at the mobile device in response to the triggering event being detected, and transmitting the control signal from the mobile device to the home device through a network via a proprietary router in response to the triggering event being detected.

In addition to one or more of the features described above, or as an alternative, further embodiments of the method include, wherein transmitting the control signal from the mobile device to the home device through the network using the proprietary router by point-to-point communication through the known path of communication includes transmitting the control signal from the mobile device to the proprietary router over the network implemented over internet resources, receiving the control signal at the proprietary router and processing the control signal to determine the known path of communication for the home device the control signal is configured to control, routing the control signal from the proprietary router using point-to-point communication through other devices on the network, and receiving the control signal at the home device.

In addition to one or more of the features described above, or as an alternative, further embodiments of the method include, wherein transmitting the control signal from the mobile device to the home device through the network using the proprietary router by point-to-point communication through the known path of communication includes transmitting the control signal from the mobile device to a customer terminal through the proprietary router, wherein the customer terminal is locally connected to the home device, receiving the control signal at the customer terminal for controlling the home device locally connected to the customer terminal, and transmitting the control signal from the customer terminal to the home device.

In addition to one or more of the features described above, or as an alternative, further embodiments of the method include, wherein transmitting the control signal from the mobile device to the home device through the network using the proprietary router by point-to-point communication through the known path of communication includes transmitting the control signal from the mobile device to a home automation server (HAS) through the proprietary router, wherein the HAS is configured for controlling the home device, receiving the control signal at the HAS, wherein the HAS is connected along the known communication path to the home device, and transmitting the control signal from the HAS to the home device.

In addition to one or more of the features described above, or as an alternative, further embodiments of the method include, wherein the triggering event includes triggering event information that includes at least one selected from a group consisting of a user input, a geofence trigger signal, a scheduled instruction, a threshold sensor reading, and a third party request.

In addition to one or more of the features described above, or as an alternative, further embodiments of the method includes, wherein the home device is selected from a group consisting of a customer terminal, a thermostat, a mechanical servo device, a light switch, a video camera, a digital electronic device, a home appliance, a home audio device, a sensor array, and a security system sensor.

In addition to one or more of the features described above, or as an alternative, further embodiments of the method include, wherein generating the control signal at the mobile device includes deriving triggering event information from the triggering event, processing the triggering event information, processing control information received from one or more of a group consisting of a user input, a geofence trigger signal, a scheduled instruction, a threshold sensor reading, a third party request, and a stored data file associated with the independent home device that is to be controlled, and generating the control signal based on the triggering event information and control information.

In addition to one or more of the features described above, or as an alternative, further embodiments of the method include, wherein transmitting the control signal from the mobile device to home device through the network using the proprietary router by point-to-point communication through the known path of communication includes using a protocol translator communicatively connected to the proprietary router that takes the control signal from a source and translates the control signal into a format readable by a destination in the known path of communication and the home device.

In addition to one or more of the features described above, or as an alternative, further embodiments of the method include, wherein the control signal is translated from a source protocol to a destination protocol, and wherein the protocol translator further includes a source protocol identifier adapted to identify the source protocol, and a destination protocol identifier adapted to identify the destination protocol, wherein the source protocol identifier includes an association between the source and the corresponding source protocol, and wherein the destination protocol identifier includes an association between the destination and the corresponding destination protocol.

According to one embodiment, a system for routing signals and controlling a home device using a mobile device is provided. The system includes a network including a plurality of communication points that provide path of communication between connected devices, wherein the network is adapted to communicate via Internet resources, a home device that is communicatively connected using the network, a mobile device that is communicatively connected to the home device using the network, and a proprietary router in the network through which the mobile device is able to connect to the home device, wherein the mobile device is configured to detect a triggering event at the mobile device, wherein the triggering event is associated with a control signal for controlling the home device, generate the control signal in response to the triggering event being detected, and transmit the control signal to the home device through the network using the proprietary router through the path of communication in response to the triggering event being detected.

In addition to one or more of the features described above, or as an alternative, further embodiments of the system include a network device that uses a first communication and signaling protocol, and a customer terminal that uses a second communication and signaling protocol different from the first communication and signaling protocol, wherein the network device communicates with a network device management server using the first communication and signaling protocol, wherein the customer terminal communicates with a network-based protocol translator adapted to convert the second communication and signaling protocol to a third communication and signaling protocol, and wherein the network device management server is adapted to communicate using the third communication and signaling protocol.

In addition to one or more of the features described above, or as an alternative, further embodiments of the system include, wherein the mobile device communicates with the customer terminal via the network, and wherein the customer terminal forwards messages from the mobile device to the network device via the protocol translator and the network device.

In addition to one or more of the features described above, or as an alternative, further embodiments of the system include, wherein the system is further configured to transmit the control signal from the mobile device to the proprietary router over the network implemented over Internet resources, receive the control signal at the proprietary router and process the control signal to determine the known path of communication for the home device the control signal is configured to control, route the control signal from the proprietary router using point-to-point communication through other devices on the network, and receive the control signal at the home device.

In addition to one or more of the features described above, or as an alternative, further embodiments of the system include, a customer terminal, wherein the home device is locally connected to the customer terminal, wherein the system is further configured to transmit the control signal from the mobile device to the customer terminal through the proprietary router, receive the control signal at the customer terminal for controlling the home device locally connected to the customer terminal, and transmitting the control signal from the customer terminal to the home device.

In addition to one or more of the features described above, or as an alternative, further embodiments of the system include a home automation server (HAS), wherein the system is configured to transmit the control signal from the mobile device to the HAS through the proprietary router, wherein the HAS is configured for controlling the home device, receive the control signal at the HAS, wherein the HAS is connected along the known communication path to the home device, and transmit the control signal from the HAS to the home device.

In addition to one or more of the features described above, or as an alternative, further embodiments of the system include wherein the triggering event includes triggering event information that includes at least one selected from a group consisting of a user input, a geofence trigger signal, a scheduled instruction, a threshold sensor reading, and a third party request, and wherein the home device is selected from a group consisting of a customer terminal, a thermostat, a mechanical servo device, a light switch, a video camera, a digital electronic device, a home appliance, a home audio device, a sensor array, and a security system sensor.

In addition to one or more of the features described above, or as an alternative, further embodiments of the system include, wherein generating the control signal at the mobile device includes deriving triggering event information from the triggering event, processing the triggering event information, processing control information received from one or more of a group consisting of a user input, a geofence trigger signal, a scheduled instruction, a threshold sensor reading, a third party request, and a stored data file associated with the independent home device that is to be controlled, generating the control signal based on the triggering event information and control information.

In addition to one or more of the features described above, or as an alternative, further embodiments of the system include a protocol translator communicatively connected to the proprietary router, wherein transmitting the control signal from the mobile device to the home device through the network using the proprietary router by point-to-point communication through a known path of communication includes using the protocol translator to take the control signal and translate the control signal into a format readable by other devices in the known path of communication and the home device.

According to one embodiment, a network-based protocol translator includes a protocol converter adapted to convert first messages in a first protocol of a first group of communication protocols to messages in one or more second protocols in a second group of communication protocols, wherein the first group of communication protocols include a source protocol, and wherein the one or more second protocols include a destination protocol.

In addition to one or more of the features described above, or as an alternative, further embodiments of the network-based protocol translator include a translation engine, wherein the translation engine includes source protocol identification means adapted to identify the source protocol.

In addition to one or more of the features described above, or as an alternative, further embodiments of the network-based protocol translator include a translation engine, wherein the translation engine includes destination protocol identification means adapted to identify the destination protocol or protocols.

In addition to one or more of the features described above, or as an alternative, further embodiments of the network-based protocol translator include, wherein the translation engine includes destination protocol identification means adapted to identify the destination protocol or protocols.

In addition to one or more of the features described above, or as an alternative, further embodiments of the network-based protocol translator include, wherein the source protocol identification means includes an association between the source and the corresponding source protocol.

In addition to one or more of the features described above, or as an alternative, further embodiments of the network-based protocol translator include, wherein the destination protocol identification means includes an association between the destination and the corresponding destination protocol.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The foregoing and other features, and advantages of the present disclosure are apparent from the following detailed description taken in conjunction with the accompanying drawings in which:

FIG. 1 illustrates a block diagram illustrating basic elements of a network architecture, including alarm delivery, network management and remote control according to one or more embodiments of the disclosure.

FIG. 2 illustrates a flow diagram illustrating interactions between the various subsystems of the mobile terminal and the customer terminal used according to one or more embodiments of the disclosure.

FIG. 3 illustrates a block diagram illustrating a network device (3.40) and associated server (3.30) wherein the network device is controlled using a mobile terminal via proprietary routers (3.14) without the involvement of the customer terminal according to one or more embodiments of the disclosure.

FIG. 4 illustrates a flow diagram associated with the system of FIG. 3 illustrating interactions between a mobile terminal and a server via the proprietary routers used to control a remote network device such as a thermostat according to one or more embodiments of the disclosure.

FIG. 5 illustrates a block diagram illustrating additional features of a network including a mobile terminal controlling one or more customer terminals and one or more network devices via proprietary routers whereby the customer terminal intermediates the communication between the mobile terminal and the one or more network-based servers used to control the network devices according to one or more embodiments of the disclosure.

FIG. 6 illustrates a flow diagram illustrating interactions between various functional blocks associated with the network detailed in FIG. 5 according to one or more embodiments of the disclosure.

FIG. 7 illustrates a block diagram of the customer terminal illustrating the functional blocks used according to one or more embodiments of the disclosure.

FIG. 8 illustrates a network diagram illustrating additional features of a network including the utilization of a local area wireless network such as Z-Wave to control home automation devices according to one or more embodiments of the disclosure.

FIG. 9 illustrates an arrangement which enables a customer terminal to communicate with an operable device (9.40) having a different signal protocol from that of the customer terminal controllable via a network server (9.30) according to one or more embodiments of the disclosure.

FIG. 10 illustrates a protocol translator according to one or more embodiments of the disclosure.

FIG. 11 illustrates an exemplary message format for a message sent from the customer terminal according to one or more embodiments of the disclosure.

FIG. 12 illustrates an exemplary message format for a message sent from the protocol translator according to one or more embodiments of the disclosure.

FIG. 13 illustrates an exemplary message format for a message sent from the home automation system according to one or more embodiments of the disclosure.

FIG. 14 illustrates a flowchart of a method for routing signals and controlling a plurality of independent home devices using a mobile device according to one or more embodiments of the disclosure.

FIG. 15 illustrates a flowchart of some additional operations for a method for routing signals and controlling a plurality of independent home devices using a mobile device according to one or more embodiments of the disclosure.

FIG. 16 illustrates system having more than one mobile device associated with a customer terminal according to one or more embodiments of the disclosure.

### DETAILED DESCRIPTION

One or more embodiments described herein are directed to a method and/or system for routing signals and controlling a plurality of independent home devices using a mobile device or a home based controller. The system may include one or more mobile devices connected to both a proprietary router and one or more of a plurality of independent home devices used by the user. The mobile device may be adapted to control the home devices via a home based controller. Control of the home devices may be via a home automation server. This method and system could improve the privacy of systems that are accessed or controlled remotely using a portable device such as a mobile telephone. The method and system also have application in the field of geolocation. According to one or more embodiments of the disclosure, the system and method may be used to improve the user experience associated with remotely controlling devices generally, but will be described with reference to security and home automation systems. According to one aspect of the disclosure, the use of a distributed network architecture to facilitate communications between customer terminals and mobile terminals is disclosed.

Some embodiments utilize a proprietary router The proprietary router is one which is accessible via a proprietary message from an associated edge device and which processes such proprietary messages in a predetermined manner. The proprietary router may be configured to connect specified terminals to associated terminals. The proprietary router may be adapted to terminate an incoming tunnel and establish an outgoing tunnel. An associated edge device may have access to a dedicated port of a proprietary router. Proprietary routers can be accessed via a public network.

A proprietary router can be adapted to be associated with a wide area network (WAN), while remaining under the control of a proprietor of a dedicated communication network, rather than being under the control of the WAN operator. The proprietary router can have proprietary interfaces adapted to communicate with associated terminals. The network can include one or more proprietary routers.

As shown and described herein, various features of the disclosure will be presented. Various embodiments may have the same or similar features and thus the same or similar features may be labeled with the same reference numeral, but preceded by a different first number indicating the figure to which the feature is shown. Thus, for example, element “a” that is shown in FIG. X may be labeled “X.a” and a similar feature in FIG. Z may be labeled “Z.a.” Although similar reference numbers may be used in a generic sense, various embodiments will be described and various features may include changes, alterations, modifications, etc. as will be appreciated by those of skill in the art, whether explicitly described or otherwise would be appreciated by those of skill in the art.

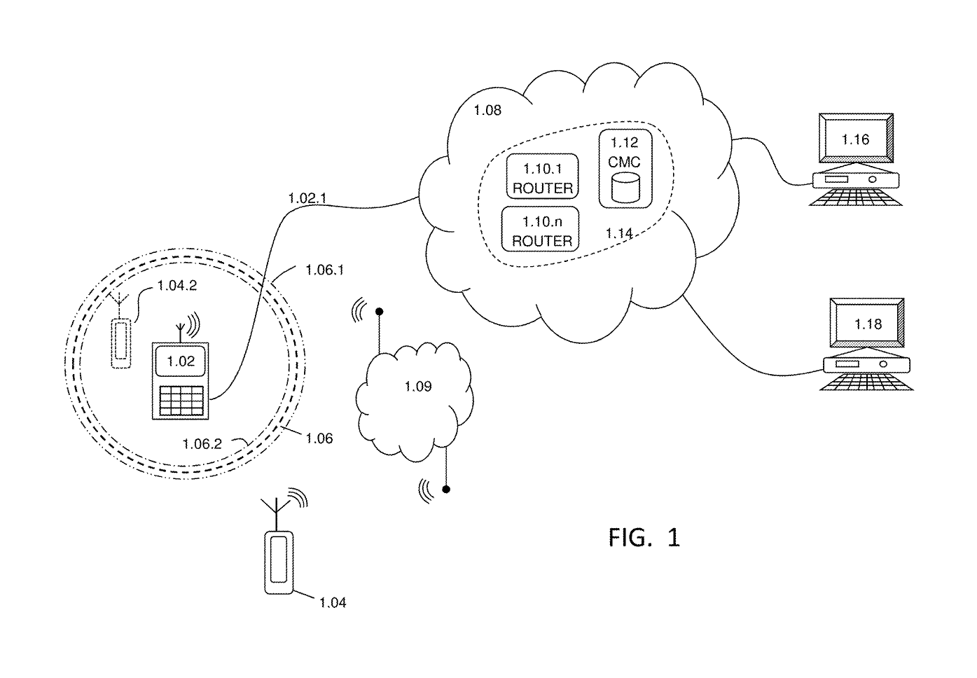

FIG. 1 depicts a block diagram illustrating basic elements of network architecture, including alarm delivery, network management and remote control according to one or more embodiments of the disclosure. Specifically, FIG. 1 shows an alarm reporting network according to an embodiment. A mobile terminal (1.04) is in communication with a customer terminal (1.02) via a virtual private network implemented over the internet (1.08). According to one embodiment, both the source and destination terminals may be in point-to-point communication with the proprietary router to establish an effective end-to-end secure tunnel. The customer terminal (1.02) may be a gateway, an alarm system, or a general device controller. The mobile terminal (1.04) may also be called a mobile user device (1.04) and can be, for example, a smartphone, tablet computer or the like with a control application that implements the disclosed method loaded and running on the mobile user device (1.04).

The network includes a plurality of customer terminals such as customer terminal (1.02), wide area networks such as WAN 1 (1.08), and WAN 2 (1.09), routers 1.10.1 through to 1.10.n. The network also includes a security company automation system, which can also be called a third party alarm automation system 1.18, a customer terminal network management terminal 1.16, as well as mobile terminals (1.04).

The routers can be dedicated routers such as the proprietary routers described in our co-pending patent application U.S. 62/083,538. As well as performing normal router functions, these routers can provide dedicated communication connections between devices registered with the routers. A communication management center (1.12) can be provided to manage the configuration of the dedicated routers.

The customer terminal can, for example, be adapted to control an alarm system including one or more wired or wireless sensors installed at the premises. In addition, in some embodiments, the customer terminal can be adapted to control a first home automation system installed at the premises. According to an embodiment, each mobile terminal (1.04) is associated with one or more customer terminals (1.02).

The mobile terminal (1.04) can include geolocation functionality. The mobile terminal (1.04) is programmable with an App which may be downloaded by the user or their agent from an internet-based third party App repository.

The mobile terminal (1.04) App is configured by the user or their agent with the geographical location of each associated customer terminal. The configuration may take the form of direct entry of coordinates indicating a map location or when the mobile terminal is physically present at the location of the customer terminal, the user or their agent may nominate that location in the App via an input field.

The App can be provided preloaded with a radius so that the radius and the location of the customer terminal as detailed above, together define a geofence with a single circular boundary as disclosed in Arkenstone U.S. Pat. No. 5,470,233. The mobile terminal (1.04) App is alerted by a trigger message generated by the intrinsic mobile terminal (1.04) geolocation capabilities that the geofence has been crossed in an inbound (in the direction towards the center of the circle) or outbound (in the direction away from the center of the circle) direction.

Hysteresis can be used to inhibit flip-flopping between states when the mobile terminal is close to the geofence, in a manner analogous to the use of hysteresis in the GSM system to avoid repetitive cell switching between adjacent cells. Upon crossing of the geofence boundary (1.06) in either inbound (1.06.2) or outbound (1.06.1) direction, the mobile terminal (1.04) App may provide the user an indication via the mobile terminal's user interface, that the geofence has been crossed. In addition, the mobile terminal (1.04) App may send a message to the customer terminal (1.02) that the geofence has been crossed and the direction of travel of the mobile terminal (inbound or outbound) relative to the customer terminal (1.02). The message is sent via the proprietary network comprised of proprietary routers (1.10.1 to 1.10.n). When the customer terminal receives either message it responds in a manner that was previously programmed by the user or their agent. For example, the user may have programmed the customer terminal to turn on the porch light when the geofence boundary is crossed in an incoming direction after 6 PM.

The App may also be adapted to obtain information from on-line sites, such as, for example the weather bureau and use the information to trigger the sending of specific instructions to the customer terminal. The App can be programmed to periodically retrieve information from the on-line site and determine if the information is within a range which requires the App to send instructions to the customer terminal. For example, if a storm is predicted, the App can use this information to instruct the customer terminal to close servo-operated shutters. The shutters or other operable devices can be controlled via wired or wireless communication links with the customer terminal and similarly when the storm has passed the App may send this information to instruct the customer terminal to open servo-operated shutters.

The customer terminal (1.02) may send a message to the mobile terminal (1.04) App to acknowledge the message it had sent and also to convey information about the status of the customer terminal after the completion of the programmed task initiated by the message from the mobile terminal (1.04) or in response to the action initiated by retrieving the on-line information.

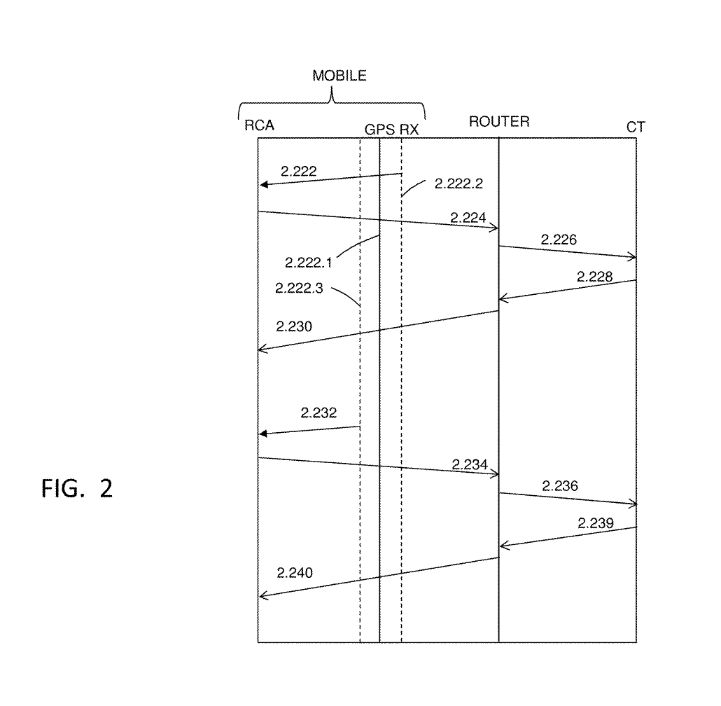

FIG. 2 is a flow diagram illustrating interactions between the various subsystems of the mobile terminal and the customer terminal used according to one or more embodiments of the disclosure. Specifically, FIG. 2 details the actions carried out by the subsystems described above. The process starts with the mobile terminal crossing the geofence in an outbound direction (2.222.2) which is identified by the GPS (2.222.1) Receiver (RX). The GPS Receiver subsystem notifies (2.222) the Remote Control App (RCA) in the mobile terminal. The RCA sends a message (2.224) to the proprietary router (2.224), that forwards it (2.226) to the customer terminal (CT). The customer terminal sends a message (2.228) to the proprietary router to acknowledge the message it had received and also to convey information about the status of the customer terminal after the completion of the programmed task initiated by the message from the mobile terminal. The proprietary router forwards the message (2.230) to the mobile terminal RCA.

A similar process takes place when the mobile terminal crosses the geofence in an inbound direction (2.222.3). This condition is identified by the GPS Receiver which notifies (2.232) the RCA in the mobile terminal. The RCA sends a message (2.234) to the proprietary router, that forwards it (2.236) to the customer terminal. The customer terminal sends a message (2.239) to the proprietary router to acknowledge the message it had received and also to convey information about the status of the customer terminal after the completion of the programmed task initiated by the message from the mobile terminal. The proprietary router forwards the message (2.240) to the mobile terminal RCA.

In response to receiving a notification that the mobile device has crossed the geofence, the customer terminal can be programmed to initiate one or more operations of the alarm system or home automation devices which the customer terminal is configured to control.

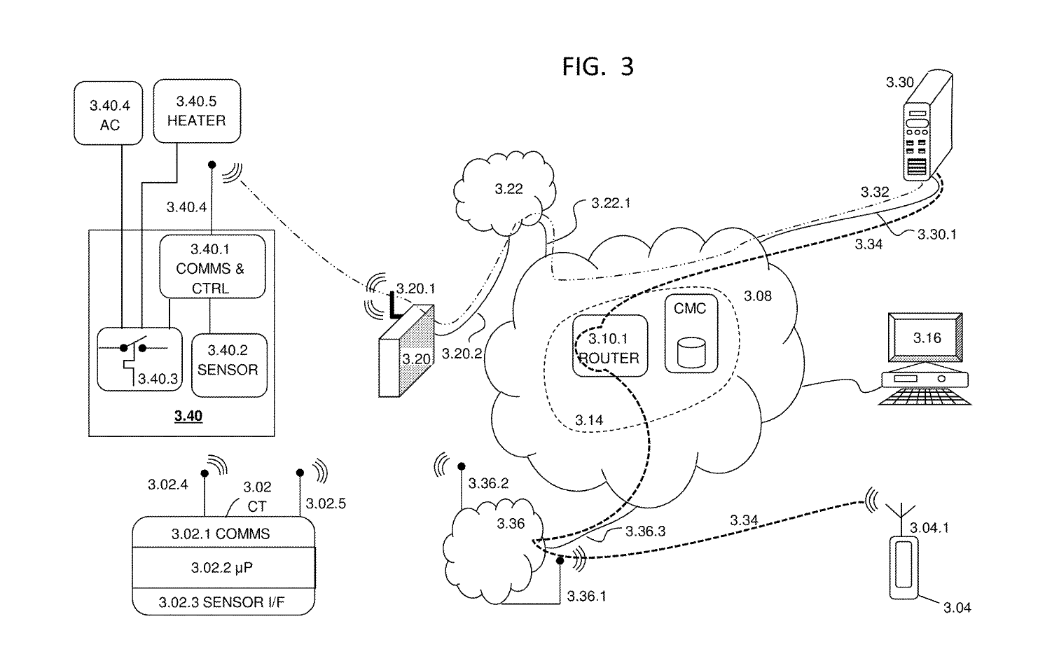

FIG. 3 is a block diagram illustrating a network device (3.40) and associated server (3.30) wherein the network device is controlled using a mobile terminal (3.04) via proprietary routers (3.14) without the involvement of the customer terminal according to one or more embodiments of the disclosure. Specifically, FIG. 3 details a further embodiment of the remote control network wherein the RCA is used to control a remote network device (3.40) which may be collocated with the customer terminal (3.02), the network device (3.40) being managed by a network-based server (3.30).

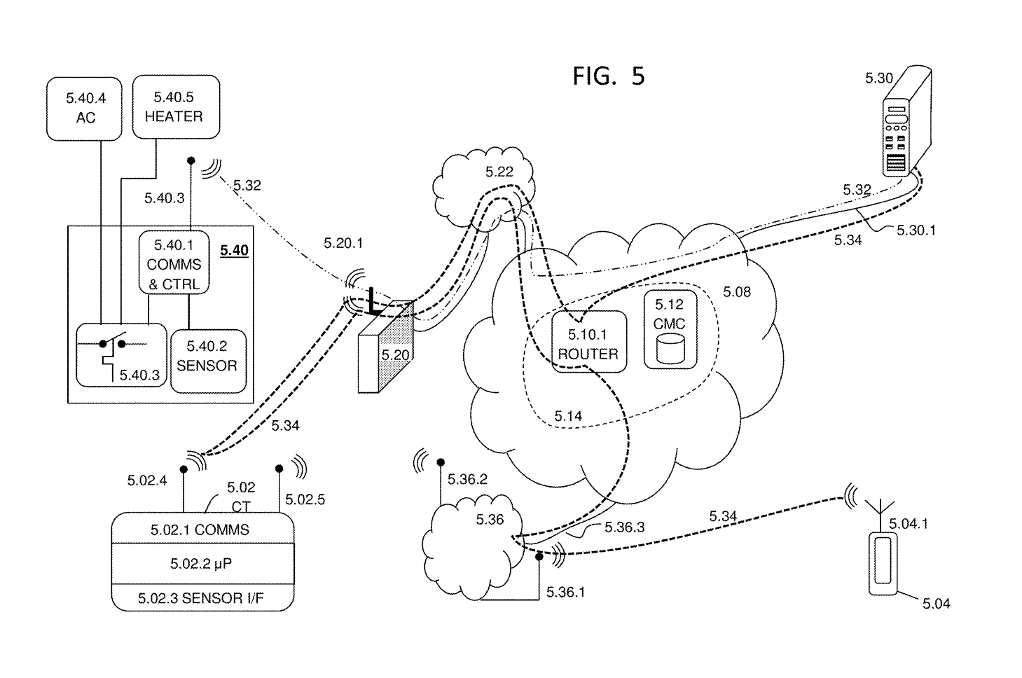

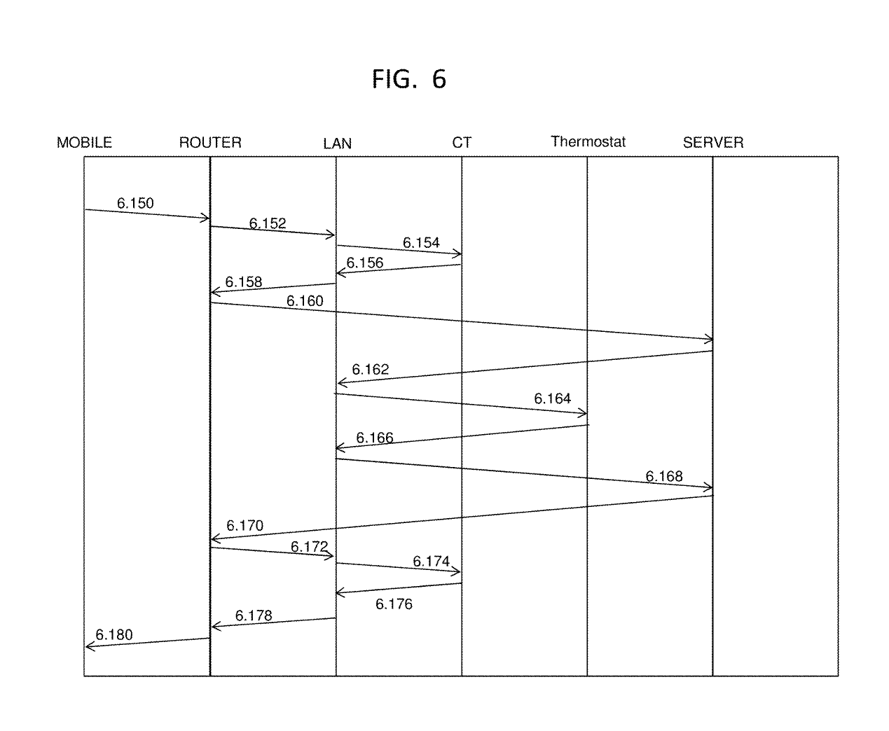

Also, as shown in FIG. 3 and in accordance with one or more embodiments, an alarm management terminal (3.16), which is adapted to manage an alarm system in communication with customer terminal (3.02), can be included. The signal protocol used for the alarm system can be a proprietary protocol associated with an alarm management terminal (AMT) (3.16) as discussed in U.S. Pat. No. 7,253,728, and the customer terminal can be similar to that discussed in U.S. 62/083,538. The customer terminal can be configured to forward messages from the mobile device (3.04) to the AMT (3.16) and to the home automation server (HAS) (3.30) as detailed in FIG. 5 and FIG. 6. The protocols used by the AMT and the HAS can be different, as can the protocols used by the alarm system and the operable devices, such as 3.40. Thus. The protocol of the operable device can be compatible with that used by the HAS, and the protocol used by the alarm system can be compatible with that used by the AMT. In this embodiment, the customer terminal protocol is not compatible with the operable devices.

The network device (3.40) may be a home automation device such as a thermostat equipped with sensors (3.40.2) and power control interfaces such as relays (3.40.3) to control HVAC devices such as air-conditioners (3.40.4) and space heaters (3.40.5). As well as being locally controllable via a local user interface, the network device (3.40) communicates using the communication and control device (3.40.1) and antenna (3.40.4) via the customer's local area network (LAN) to HAS (3.30) located off-site, for example in what has been referred to in the literature as the ‘cloud’. The HAS (3.30) will be referred to herein as a home automation server or HAS for short. The network device (3.40) can be equipped with a wireless link, such as WiFi interface (3.40.4), which is in communications with the customer premises network router (3.20) through its WiFi interface (3.20.1). The customer premises network router (3.20) can be connected to the internet (3.22 and 3.08) via a last-mile access technology such as ADSL, VDSL2, optical fiber, WiMax, cellular, such as 3G, 4G and 5G etc.

The mobile terminal (3.04) is able to control the network device (3.40) by establishing a secure IP connection (3.34) via one or more proprietary routers (3.14, 3.10.1) to the network device's HAS (3.30) and by establishing a two-way communication session with the network device's HAS (3.30). The HAS (3.30) is in two way communications with the network device (3.40) through an IP communications paths (3.22.1, 3.20.2) over the internet (3.08). The HAS (3.30) converts the control instructions from the mobile terminal (3.04) to a message format compatible with the network device (3.40) and communicates the resultant messages to the network device (3.40). The HAS (3.30) also translates the responses from the network device (3.40) to a format compatible with the mobile device (3.04) and forwards these messages to the mobile terminal (3.04).

According to one or more embodiments, the customer terminal (3.02) includes a set of antennas (3.02.4, 3.02.5) for communication with other devices includes, for example, the network device (3.40), the mobile device (3.04), and the HAS (3.30). The customer terminal (3.02) can also include a sensor I/F (3.02.3), a processor (3.02.2), and communication circuitry and devices (3.02.1).

One or more embodiments may also include a computer terminal (3.16) from which a user could login and access a portal or an instance of the control application. Therefore, the user could send and receive similar control signals from the computer terminal (3.16) for controlling the network device (3.40) and customer terminal (3.02).

According to one or more embodiments, the mobile device (3.04) can include a wireless antenna (3.04.1) through which the mobile device (3.04) is able to transmit and receive wireless signals including the control signal. Additionally, the overall system may include a cellular network device (3.36) which can include one or more cellular towers (3.36.1, 3.26.2). The cellular network device (3.36) can provide a wireless communication path (3.34) to communicate with the mobile device (3.04) and a backbone communication path (3.36.3) which can be wired or wireless that connects the wireless network (3.36) with the wide area network such as the internet (3.08) to which other device elements such as the customer terminal (3.02), the network device (3.40), and the HAS (3.30) are connected.

According to one or more embodiments, the HAS (3.30) has a data communication path (3.30.1) over which the HAS can communicate with other devices connected through the network. For example, the HAS (3.30) can communicate using communication path (3.34) with the mobile device (3.04) through the network that includes the router (3.10.1). The HAS (3.30) can also communicate using another known path of communication (3.32) with the network device (3.40) through the network. Path 3.32 may or may not include a path through proprietary router network 3.14.

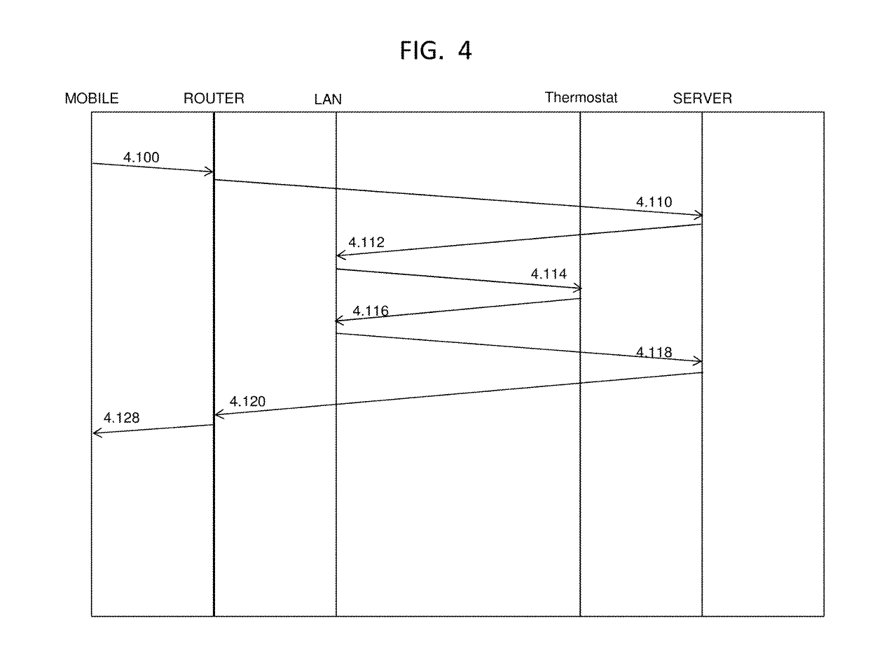

FIG. 4 is a flow diagram associated with the system of FIG. 3 illustrating interactions between a mobile terminal and a HAS via the proprietary routers used to control a remote network device such as a thermostat according to one or more embodiments of the disclosure. Particularly, FIG. 4 details the message flow associated with the system of FIG. 3 to control a remote network device by a mobile terminal as described above. For example, when a user with a mobile terminal either crosses a geofence as described above, or directly interacts with the mobile terminal via the user interface, a message (4.100) is sent by the mobile terminal to the proprietary router, which forwards the message (4.110) to the HAS. If required, the HAS may translate the message from the proprietary router format to the network device format and sends it (4.112) via the internet to the user's local area network (LAN). The message is then sent to the network device—in this case a thermostat.

The network device may respond to the server (4.116) to acknowledge the message or to deliver status indication to the server via the LAN which routes the message (4.118) over the internet to the server. The server in-turn may translate the message to a format compatible with the RCA and sent it (4.120) via the proprietary routers to the RCA executing on the mobile terminal (4.128).

FIG. 5 is a block diagram illustrating additional features of a network including a mobile terminal controlling one or more customer terminals (5.02) and one or more network devices (5.40) via proprietary routers (5.14 and 5.10.1) whereby the customer terminal (5.02) intermediates the communication between the mobile terminal (5.04) and the one or more network-based HAS (5.30) used to control the network devices (5.40) according to one or more embodiments of the disclosure. Particularly, FIG. 5 details a further embodiment of the remote control network wherein a remote network device (5.40) is controlled by a mobile terminal (5.04) or by a customer terminal (5.02) which may be controlled by a mobile terminal (5.04). One or more additional home automation systems or devices which use a protocol which is not compatible with the customer terminal may also be installed at the premises.

For example, the RCA executing on the mobile terminal (5.04) establishes point-to-point communications with the customer terminal (5.02) via secure IP VPN establishing a communication path (5.34) through the network and multiple devices. Depending on the messages received by the customer terminal (5.02) from the RCA (5.04) or other sources, the customer terminal (5.02) may control the network device (5.40) through the HAS (5.30) by translating the messages received from the RCA or other sources, from the RCA message format to the HAS (5.30) message format. The message flow (5.34) between the customer terminal (5.02) and the HAS (5.30) is via the network setup by the proprietary routers (5.14).

The RCA executing on the mobile terminal (5.04) may also enable concurrent communication with both the HAS (5.30) and the customer terminal (5.02) as detailed in both FIG. 3 and FIG. 5 so that the RCA may be programmed to convert a user command into two separate commands, one routed to the customer terminal (5.02) and the other routed to the network device (5.40) along the known path of communication (5.34) through the network.

According to one or more embodiments, the customer terminal (5.02) includes a set of antennas (5.02.4, 5.02.5) for communication with other devices includes, for example, the network device (5.40), the mobile device (5.04), and the HAS (5.30). The customer terminal (5.02) can also include a sensor I/F (5.02.3), a processor (5.02.2), and communication circuitry and devices (5.02.1).

According to one or more embodiments, the mobile device (5.04) can include a wireless antenna (5.04.1) through which the mobile device (5.04) is able to transmit and receive wireless signals including the control signal. Additionally, the overall system may include a cellular network device (5.36) which can include one or more cellular towers (5.36.1, 5.26.2). The cellular network device (5.36) can provide a wireless communication path (5.34) to communicate with the mobile device (5.04) and a backbone communication path (5.36.3) which can be wired or wireless that communications with other device elements in the networks and attached to the network such as the customer terminal (5.02), the network device (5.40), and the HAS (5.30).

According to one or more embodiments, the HAS (5.30) has a data communication path (5.30.1) over which the server can communicate with other device connected through the network. For example, the HAS (5.30) can communicate using a known path of communication (5.34) with the mobile device (5.04) through the network that includes the routers (5.10.1, 5.12, 5.14). The HAS (5.30) can also communicate using another known path of communication (5.32) to communicate with the network device (5.40) through the network.

According to one or more embodiments, the network device (5.40) may be a home automation device such as a thermostat equipped with sensors (5.40.2) and power control interfaces such as relays (5.40.3) to control HVAC devices such as air-conditioners (5.40.4) and space heaters (5.40.5). As well as being locally controllable via a local user interface, the network device (5.40) communicates using the communication and control device (5.40.1) and antenna (5.40.3) via the customer's local area network (LAN) to HAS (5.30) located off-site, for example in what has been referred to in the literature as the ‘cloud’. The network device (5.40) can be equipped with a wireless link, such as WiFi interface (5.40.3), which is in communications with the customer premises network router (5.20) through its WiFi interface (5.20.1). The customer premises network router (5.20) can be connected to the internet (5.22 and 5.08) via a last-mile access technology such as ADSL, VDSL2, optical fiber, WiMax, cellular, such as 3G, 4G and 5G etc.

FIG. 6 is a flow diagram illustrating interactions between various functional blocks associated with the network detailed in FIG. 5 according to one or more embodiments of the disclosure. Specifically, FIG. 6 outlines a message flow that may be associated with the embodiment of FIG. 5. The RCA executing on the mobile terminal may send a message (6.150) to notify or control the customer terminal and the associated network device when triggered by a predefined condition, directed by a user or as a result of the mobile terminal crossing a geofence as detailed above. The message from the RCA is received by the proprietary routers that forward the message (6.152) to the user's LAN. The customer terminal which is connected to the LAN receives the message (6.154) in LAN format.

According to one or more embodiments, as part of taking action on the received message the customer terminal may need the network device to be accessed or controlled. Accordingly, the customer terminal may direct a message (6.156) to the network device HAS, which identifies the action that the network device is instructed to take. This message is sent over the LAN and is forwarded (6.158) to the proprietary routers. The proprietary routers forward the message (6.160) to the HAS (shown as SERVER).

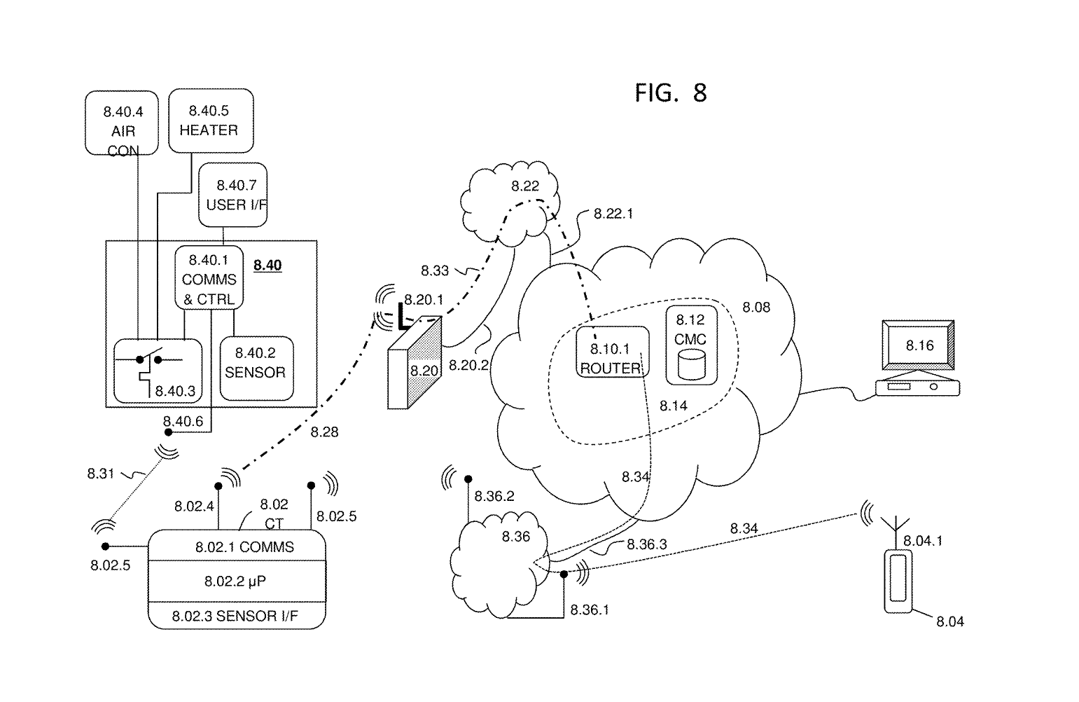

According to one or more embodiments, the message from the customer terminal is sent in customer terminal format and may be reformatted by the proprietary routers or a translation engine (see, e.g., 8.24 in FIG. 8) associated with the proprietary routers into HAS format. The HAS may change the format of the message to network device format before sending it via the LAN (6.162) to the network device (6.164).

According to one or more embodiments, the network device responds to the message received from the HAS (6.166) over the LAN, which is forwarded via the internet (6.168) to the HAS. The HAS modifies the response from the network terminal as required and sends the response (6.170) to the proprietary routers. The proprietary routers may modify the response from the HAS to convert the message format from HAS format to customer terminal format and send the resultant reformatted message via the user's LAN (6.172) to the customer terminal (6.174).

According to one or more embodiments, the customer terminal directs its response to the RCA via the LAN (6.176), through the proprietary routers (6.178) to the RCA executing on the mobile terminal (6.180).

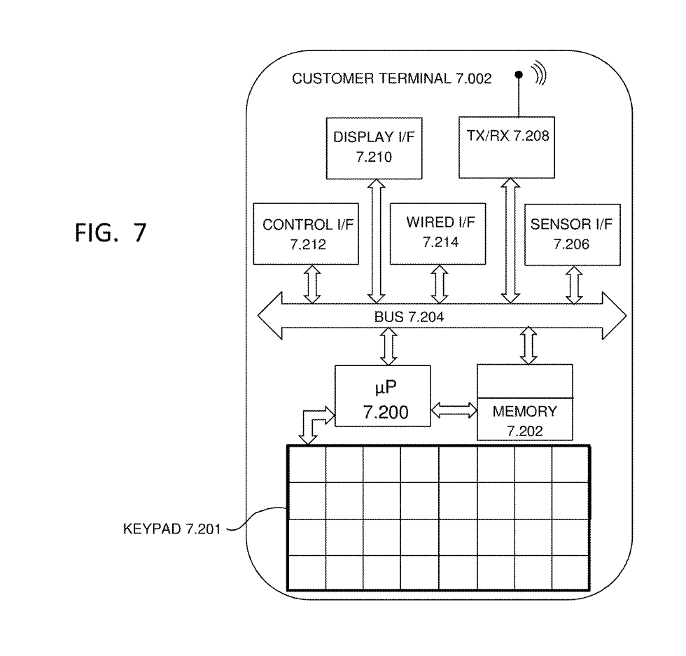

FIG. 7 is a block diagram of the customer terminal illustrating the functional blocks used according to one or more embodiments of the disclosure. Specifically, according to one or more embodiments, FIG. 7 details the customer terminal (7.002) which comprises:

(Optional) Keypad (7.201)—a basic set of buttons to provide a rudimentary user interface; (Optional) Display (7.210)—a display used to provide user feedback and may include individual LEDs, LCD or a touch-screen; Wireless IP interface (7.208)—may include WiFi (LAN), or WAN including cellular, such as 3G, 4G, LTE, 5G and the like; Sensor interface (7.206)—such as wired or wireless security and other sensors such as fire, smoke, heat, water, CO (Carbon Monoxide) etc.; Control interface (7.212)—includes wired outputs such as relay contacts and transistor open-collector outputs as well as wireless home automation devices such as Z-Wave control devices; Microprocessor (7.200)—used to execute the customer terminal firmware using the instructions and data, including user-entered configuration data, stored in Memory (7.202) which may include both volatile and non-volatile memory; (Optional) Wired interface (7.214)—wired connection to LAN; and a bus interface (7.204).

FIG. 8 is a network diagram illustrating additional features of a network in the case where the network devices (8.40) are equipped with a means of communication compatible with the customer terminal (8.02). For example, a wireless link (8.31), such as a Z-Wave link can be used by the customer terminal to control the network device (8.40) either directly via the customer terminal (8.02) keypad (7.201) or via mobile device 8.04. When the control is via the mobile device (8.04), the proprietary router (8.10.1) provides a secure path (8.33, 8.28) to the customer terminal (8.02).

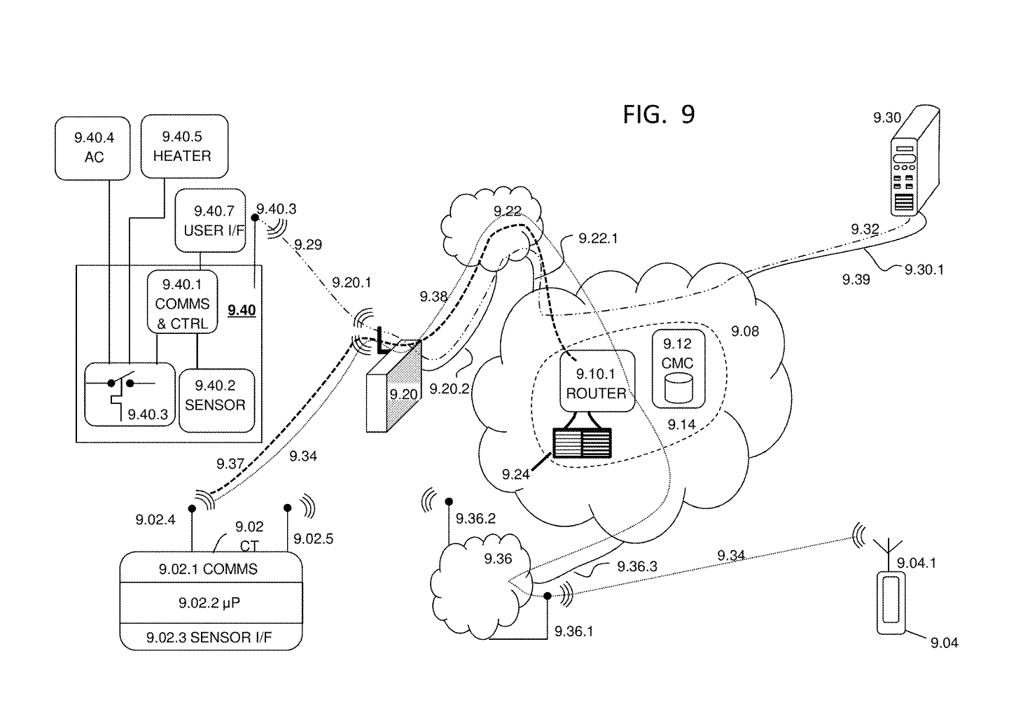

FIG. 9 illustrates another embodiment wherein there is no compatible communication link between the customer terminal (9.02) and the network device 9.40.

In this case commands to the network device (9.40), which may originate from the mobile device (9.04) or from the customer terminal keypad (7.201) or from the customer terminal (9.02) itself are sent via proprietary router (9.10.1) to HAS (9.30), and from the HAS (9.30) to the network device 9.40. However, the customer terminal (9.02) may not use a communication and signaling protocol which is compatible with the HAS (9.30). This necessitates a translation of the message protocol used by the customer terminal to the protocol which the HAS (9.30) is adapted to receive. To achieve this, a protocol translator (9.24) is provided. In this embodiment the protocol translator (9.24) is based in the communication network 9.08. The protocol translator (9.24) can be associated with the proprietary router network, and, in this embodiment, it is associated with proprietary router 9.10.1. Depending on the communication systems for which the source and destination terminals are configured, the protocol translator may be configured to convert only the instructions in the message payload from a first signaling protocol to a second signaling protocol, or the translator may be configured to change both the instructions and the message header from a first communication protocol to a second communication protocol.

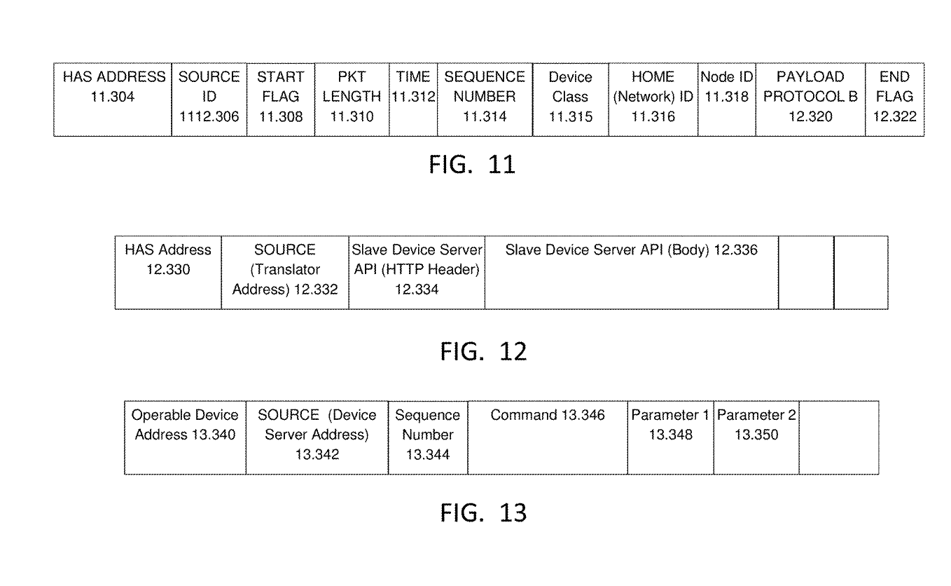

According to one or more embodiments, the Z-Wave messages to control the associated network devices are incorporated into one or more IP messages by the customer terminal (9.02) and sent over an IP point-to-point connection (9.37) via its WiFi LAN interface (9.02.4) to the customer's network router (9.20). The customer's network router (9.20) routes the messages over the internet (9.22 and 9.08) to the proprietary router (9.10.1). As described below with reference to FIGS. 11, 12, and 13, translation engine (9.24) is associated with the proprietary router (9.10.1), and converts the Z-Wave messages to a format compatible with the HAS (9.30) and the HAS (9.30) translates the messages from the HAS to a format compatible with the network devices (9.40) which are forwarded by the HAS (9.30) to control the network device (9.40).

According to one or more embodiments, the translation engine (9.24) can be incorporated in a separate platform from the proprietary router (9.10.1).

According to one or more embodiments, the proprietary router (9.10.1) maintains a register used to maintain the association between customer terminal (9.04) identifiers and associated network device identifiers (9.40). In the present embodiment, the proprietary router (9.10.1) can be adapted to provide two-way mapping between Z-Wave commands issued by customer terminals (9.02) and network device commands issued by the HAS (9.30).

According to one or more embodiments, the customer terminal (9.02) includes a set of antennas (8.02.4, 8.02.5) for communication with other devices including, for example, the mobile device (8.04), and the HAS (9.30) via the customer premises LAN 9.20 or the cellular network (9.02.5). As described in more detail above with reference to FIG. 7, the customer terminal (9.02) can also include a sensor interface (9.02.3) (e.g., for fire alarm sensors), a processor (9.02.2), and communication circuitry and devices (9.02.1).

According to one or more embodiments, the mobile device (9.04) can include a wireless transceiver antenna (9.04.1) through which the mobile device is able to transmit and receive wireless signals including the control signal. Additionally, the overall system may include a cellular network (9.36) which can include one or more cellular towers (9.36.1, 9.26.2). The cellular network (9.36) can provide a wireless communication path to communicate with the mobile device (9.04) and a backbone communication path (9.36.3) which can be wired or wireless that links the cellular network with the internet (9.08) to provide communication between the mobile device (9.04) and other devices connected to the network such as the customer terminal (9.02), the network device (9.40), and the HAS (9.30).

According to one or more embodiments, the HAS (9.30) has a data communication path (9.30.1) over which the server can communicate with other device connected through the network. For example, the HAS (9.30) can communicate using communication path (9.34) with the mobile device (9.04) through the network that includes the router (9.10.1). The HAS (9.30) can also communicate using another communication path (9.32) to communicate with the network device (9.40) through the network.

According to one or more embodiments, the network device (9.40) may be a home automation device such as a thermostat equipped with sensors (9.40.2) and power control interfaces such as relays (9.40.3) to control HVAC devices such as air-conditioners (9.40.4) and space heaters (9.40.5). As well as being locally controllable via a local user interface (9.40.7), the network device (9.40) communicates using the communication and control device (9.40.1) and antenna (9.40.3) via the customer's local area network (LAN) to HAS (9.30) located off-site, for example in what has been referred to in the literature as the ‘cloud’. The network device (9.40) can be equipped with a wireless link, such as WiFi interface (9.40.3), which is in communications with the customer premises network router (9.20) through its WiFi interface (9.20.1). The customer premises network router (9.20) can be connected to the internet (9.22 and 9.08) via a last-mile access technology such as ADSL, VDSL2, optical fiber, cellular, such as 3G, 4G and 5G etc.

Further, according to one or more embodiments, FIG. 9 illustrates an arrangement in which the customer terminal 9.02 is enabled to communicate with the operable devices (9.40) despite the operable devices having a different communication and signaling protocol from that used by the customer terminal (9.02). In this embodiment, the mobile device 9.04 is also enabled to communicate with the operable devices via the customer terminal 9.02.

In this example, it will be assumed that the customer terminal is adapted to communicate by a first protocol, for example Z-Wave, while the operable devices use a second protocol, such as WiFi.

Where a message is to be sent from the customer terminal (9.02) to the operable device (9.40), a Z-Wave message is formed into IP packets by the customer terminal (9.02) and sent to the proprietary router (9.10.1) either via the premises LAN 9.20 via either a wired or wireless link, or via packet wireless via an inbuilt wireless link (9.02.5) in the customer terminal 9.02 to wireless network 9.36. The proprietary router sends the message to an associated protocol translator 9.24 which then disassembles the message and converts the message contents to a third protocol suitable for the HAS (9.30). The message is then re-packetized and sent to the HAS (9.30). The HAS in turn converts the message from the third protocol to the second protocol and forwards the message to the operable device (9.40). This process is schematically illustrated by the message packets shown at FIGS. 11, 12, and 13.

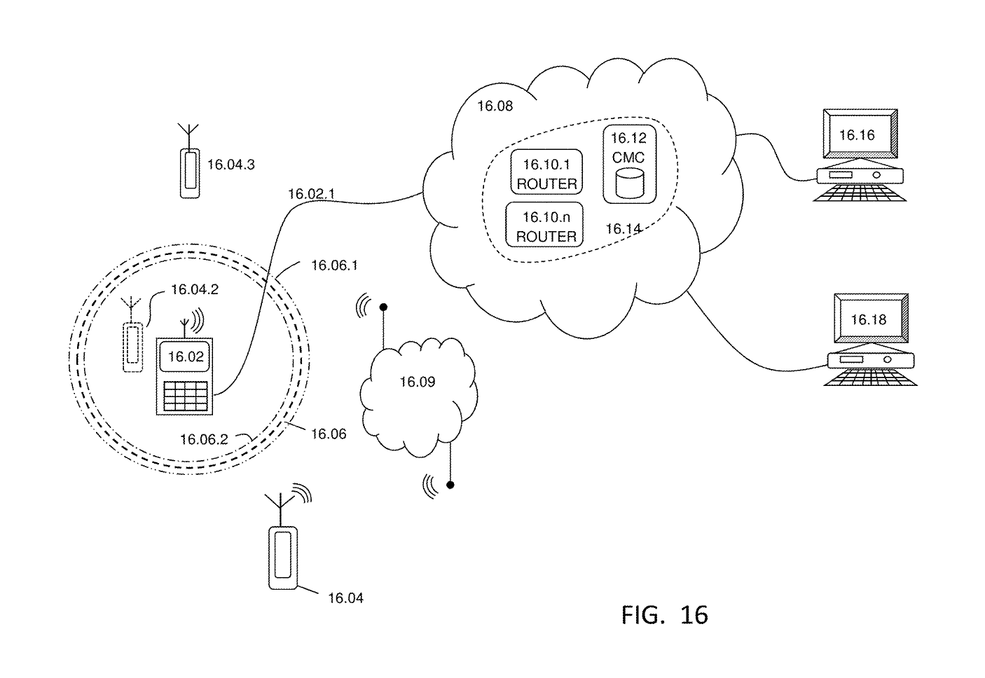

FIG. 16 illustrates a further embodiment of the invention. In this embodiment, more than one mobile device (16.04, 16.04.2, 16.04.3) configured with the App (RCA) can be associated with the customer terminal (CT) (16.02). When the CT is notified by the App in a first of the associated mobile devices that a geofence crossing has taken place, the CT is adapted to poll the other associated mobile devices to determine whether to act on the notification of a geofence crossing by the first mobile device associated with the CT (16.02).

As shown in FIG. 16, a first mobile device 16.04 and a second mobile device 16.04.3 are shown outside the geofence 16.06, and a second mobile device 16.04.2 is shown inside the geofence.

When the mobile device 16.04 crosses the geofence, the App in that mobile device will notify the CT (16.02). However, the CT in this embodiment is programmed to conduct a polling operation of any other mobile devices which have been associated with the CT (16.02) to determine the location of the other mobile devices in relation to the geofence.

If, for example, no other mobile device is within the geofence, the CT (16.02) will implement a first pre-programmed routine which may be dependent on time of day, season, temperature, etc.

However, if a mobile device is located within the geofence, the CT (16.02) can be programmed to implement a second set of actions or to ignore the new geofence crossing.

Where a second mobile device is within the geofence, the CT (16.02) can be programmed to implement a second set of actions on notification of the crossing of the geofence by the first mobile device. The second set of actions may be dependent on the identification of the mobile device. Thus each of the mobile devices can be used to trigger specific actions while taking account of the presence of another mobile device within the geofence.

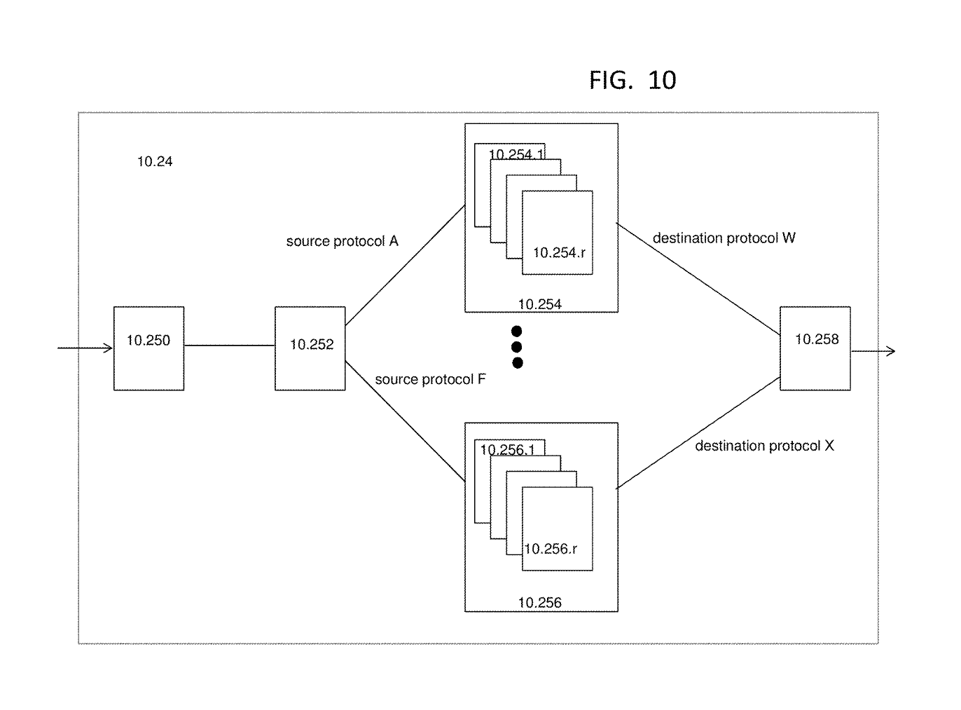

FIG. 10 illustrates a web-based protocol translator 10.24 adapted to convert any of a first set of communication and signaling protocols to any of a second set of communication and signaling protocols in accordance with one or more embodiments. The protocol translator includes a packet disassembler 10.250, a protocol identifier 10.252. and one or more multiple protocol translation engines 10.254 . . . 10.256, and a packet assembler 10.258. Each translation engine can consist of a set of translation tables or conversion algorithms 10.254.1 . . . 10.254.r, adapted to convert a specific incoming protocol to a designated output protocol using the corresponding one of the set of translation tables.

The incoming message is un-packetized at disassembler 10.250, the address information and other required identification information being preserved. The incoming is protocol identified and the outgoing protocol ascertained either from information in the incoming message or from information programmed into the protocol translator. For example, the translator may include information correlating destination addresses with the required protocol for that address.

When the incoming protocol is ascertained, the message to be translated is directed to the appropriate set of translation tables or algorithm for the identified incoming protocol and the appropriate table converting the incoming protocol to the protocol for the destination address is chosen.

A new message with appropriate header addresses and identification information is then assembled with the translated message.

In the case where there is only one known incoming protocol and only one known outgoing protocol, identification of the incoming and outgoing protocols is unnecessary, and only a single translation table is required.

As shown in FIG. 11, and in accordance with one or more embodiments, the customer terminal assembles a message with header fields, e.g., HAS address (11.304), source ID (11.306), start flag (11.308), packet length (11.310), time (11.312), sequence number (11.314), device class (11.315), home ID (11.316), node ID (11.318), and payload (11.320). An end flag (11.322) indicates the end of the packet. The device class and node ID serve to identify the operable device to which the message is directed.

In FIG. 12. the protocol translator then disassembles the packet from the customer terminal and converts the payload (11.320 in FIG. 11) to a format suitable for the HAS, for example an application programming interface (API) format having API header (12.334) and body (12.336). The translator then assembles a second message by adding the HAS address (12.330) as the destination address, the translator address (12.332) as the source address. The second message is then sent to the HAS. Information enabling identification of the target operable device is preserved in this second message to enable the HAS to forward the message to the selected destination device. A mapping capability can be provided in the customer terminal or in the proprietary router to map Node ID to the customer account identifier used by the HAS to identify the network device.

The message prepared by the HAS is shown in FIG. 13. The HAS identifies the target operable device and converts the incoming instructions to command 13.346 and parameters 13.348, 13.350 recognized by the operable device, adds the destination address of the target operable device to form a third message and sends the third message to the target operable device.

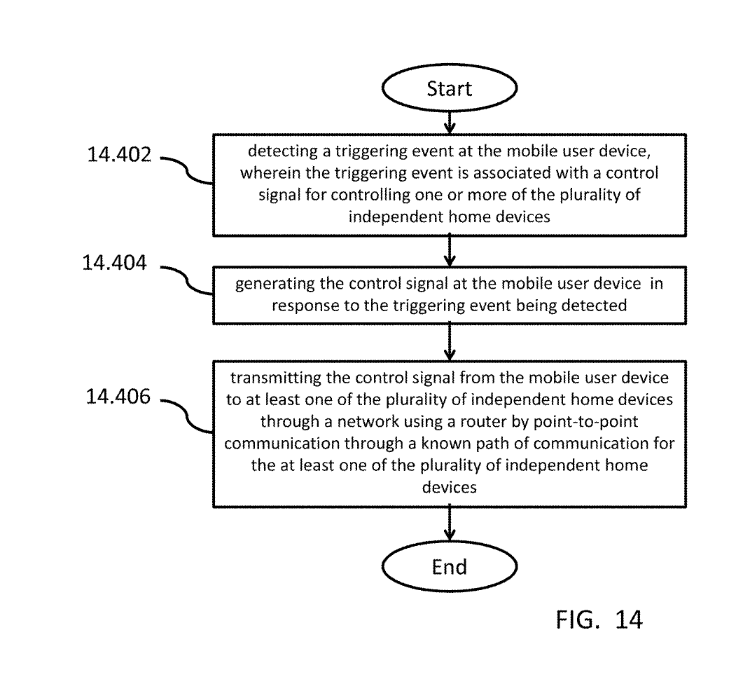

FIG. 14 depicts a flowchart of a method for routing signals and controlling a plurality of independent home devices using a mobile device according to one or more embodiments of the disclosure. The method of routing signals and controlling a plurality of independent home devices using a mobile device includes detecting a triggering event at the mobile device, wherein the triggering event is associated with a control signal for controlling one or more of the plurality of independent home devices (operation 14.402). The method also includes generating the control signal at the mobile device in response to the triggering event being detected (operation 14.404). Further, the method includes transmitting the control signal from the mobile device to at least one of the plurality of independent home devices through a network using a router by point-to-point communication through a known path of communication for the at least one of the plurality of independent home devices (operation 14.406).

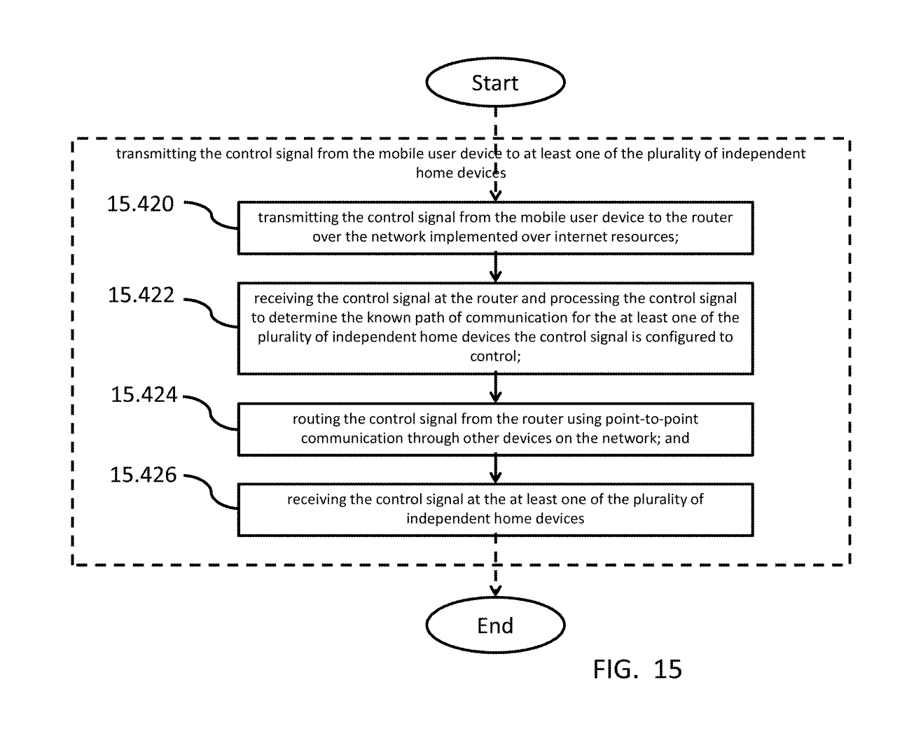

FIG. 15 shows a flowchart of some additional operations for a method for routing signals and controlling a plurality of independent home devices using a mobile device according to one or more embodiments of the disclosure. The method includes transmitting the control signal from the mobile device to the router over the network implemented over internet resources (operation 15.420). The method also includes receiving the control signal at the router and processing the control signal to determine the known path of communication for the at least one of the plurality of independent home devices the control signal is configured to control (operation 15.422). Further, the method includes routing the control signal from the router using point-to-point communication through other devices on the network (operation 15.424). The method also includes receiving the control signal at the at least one of the plurality of independent home devices (operation 15.426).

According to another embodiment, the method can also include transmitting the control signal from the mobile user device to a customer terminal through the router, wherein the customer terminal is locally connected to the plurality of independent home devices. The method also includes receiving the control signal at the customer terminal for controlling one or more of the plurality of independent home devices locally connected to the customer terminal. Further, the method includes transmitting the control signal from the customer terminal to at least one of the plurality of independent home devices.

According to another embodiment, the method can also include transmitting the control signal from the mobile user device to a HAS through the router, wherein the HAS is configured for controlling the at least one of the plurality of independent home devices. The method also includes receiving the control signal at the HAS, wherein the HAS is connected along the known communication path to at least one of the plurality of independent home devices. The method also includes transmitting the control signal from the HAS to the at least one of the plurality of independent home devices.

According to one or more embodiments the HAS can be used as a routing point similar to the proprietary router. According to another embodiment, the triggering event includes the mobile user device triggering a geofence boundary.

Further, the triggering event includes triggering event information that includes at least one selected from a group consisting of a user input, a geofence trigger signal, a scheduled instruction, a threshold sensor reading, and a third party request according to one or more embodiments.

According to one or more embodiments, the plurality of independent home devices includes at least one or more from a group consisting of a customer terminal, a thermostat, a mechanical servo device, a light switch, a video camera, a digital electronic device, a home appliance, a home audio device, a sensor array, and a security system sensor.

According to another embodiment, generating the control signal at the mobile user device includes deriving triggering event information from the triggering event and processing the triggering event information. The method also includes processing control information received from one or more of a group consisting of a user input, a geofence trigger signal, a scheduled instruction, a threshold sensor reading, a third party request, and a stored data file associated with the independent home device that is to be controlled and generating the control signal based on the triggering event information and control information.

According to another embodiment, transmitting the control signal from the mobile user device to at least one of the plurality of independent home devices through a network using a router by point-to-point communication through a known path of communication for the at least one of the plurality of independent home devices includes using a protocol translator in the router that takes the control signal and translates the control signal into a format readable by other devices in the known path of communication and the at least one of the plurality of independent home devices.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description has been presented for purposes of illustration and description, but is not intended to be exhaustive or limited to the embodiments in the form disclosed. Many modifications and variations will be apparent to those of ordinary skill in the art without departing from the scope of the disclosure. The embodiments were chosen and described in order to best explain the principles of the disclosure and the practical application, and to enable others of ordinary skill in the art to understand various embodiments with various modifications as are suited to the particular use contemplated.

The present embodiments may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Java, Smalltalk, C++, or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of one or more embodiments are described herein with reference to flowchart illustrations and/or block diagrams of methods, apparatus (systems), and computer program products according to embodiments. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A mobile device for routing signals and controlling a home device, the mobile device comprising a computer readable storage medium having program instructions embodied therewith, the program instructions executable by a processor of the mobile device to cause the processor to:
detect a triggering event at the mobile device, wherein the triggering event is associated with a control signal for controlling the home device;
generate the control signal in response to the triggering event being detected; and
transmit the control signal from the mobile device to the home device through a network using a proprietary router associated with the home device in response to the triggering event being detected.

2. The mobile device of claim 1, wherein the mobile device further comprises additional program instructions executable by the processor of the mobile device to cause the processor to:
detect a crossing by the mobile device of a specified geofence based on geolocation capability and geofence detecting capability of the mobile device; and
transmit a message to a terminal through the proprietary router in response to the detection of said crossing,
wherein the proprietary router is adapted to establish a secure communication tunnel between the proprietary router and the terminal.

3. A method of routing signals and controlling a home device using a mobile device, the method comprising:
detecting a triggering event at the mobile device, wherein the triggering event is associated with a control signal for controlling the home device;
generating the control signal at the mobile device in response to the triggering event being detected; and
transmitting the control signal from the mobile device to the home device through a network via a proprietary router in response to the triggering event being detected.

4. The method of claim 3, wherein transmitting the control signal from the mobile device to the home device through the network using the proprietary router by point-to-point communication through the known path of communication comprises:
transmitting the control signal from the mobile device to the proprietary router over the network implemented over internet resources;
receiving the control signal at the proprietary router and processing the control signal to determine the known path of communication for the home device the control signal is configured to control;
routing the control signal from the proprietary router using point-to-point communication through other devices on the network; and
receiving the control signal at the home device.

5. The method of claim 3, wherein transmitting the control signal from the mobile device to the home device through the network using the proprietary router by point-to-point communication through the known path of communication comprises:
transmitting the control signal from the mobile device to a customer terminal through the proprietary router, wherein the customer terminal is locally connected to the home device;
receiving the control signal at the customer terminal for controlling the home device locally connected to the customer terminal; and
transmitting the control signal from the customer terminal to the home device.

6. The method of claim 3, wherein transmitting the control signal from the mobile device to the home device through the network using the proprietary router by point-to-point communication through the known path of communication comprises:
transmitting the control signal from the mobile device to a home automation server (HAS) through the proprietary router, wherein the HAS is configured for controlling the home device;
receiving the control signal at the HAS, wherein the HAS is connected along the known communication path to the home device; and
transmitting the control signal from the HAS to the home device.

7. The method of claim 3, wherein the triggering event includes triggering event information that includes at least one selected from a group consisting of a user input, a geofence trigger signal, a scheduled instruction, a threshold sensor reading, and a third party request.

8. The method of claim 3, wherein the home device is selected from a group consisting of a customer terminal, a thermostat, a mechanical servo device, a light switch, a video camera, a digital electronic device, a home appliance, a home audio device, a sensor array, and a security system sensor.

9. The method of claim 3, wherein generating the control signal at the mobile device includes:
deriving triggering event information from the triggering event;
processing the triggering event information;
processing control information received from one or more of a group consisting of a user input, a geofence trigger signal, a scheduled instruction, a threshold sensor reading, a third party request, and a stored data file associated with the independent home device that is to be controlled; and
generating the control signal based on the triggering event information and control information.

10. The method of claim 3, wherein transmitting the control signal from the mobile device to home device through the network using the proprietary router by point-to-point communication through the known path of communication comprises:
using a protocol translator communicatively connected to the proprietary router that takes the control signal from a source and translates the control signal into a format readable by a destination in the known path of communication and the home device.

11. The method of claim 10, wherein the control signal is translated from a source protocol to a destination protocol, and wherein the protocol translator further comprises:
a source protocol identifier adapted to identify the source protocol; and
a destination protocol identifier adapted to identify the destination protocol,
wherein the source protocol identifier includes an association between the source and the corresponding source protocol, and
wherein the destination protocol identifier includes an association between the destination and the corresponding destination protocol.

12. A system for routing signals and controlling a home device using a mobile device, the system comprising:
a network comprising a plurality of communication points that provide a path of communication between connected devices, wherein the network is adapted to communicate via internet resources;
a home device that is communicatively connected using the network;
a mobile device that is communicatively connected to the home device using the network; and
a proprietary router in the network through which the mobile device is able to connect to the home device,
wherein the mobile device is configured to:
detect a triggering event at the mobile device, wherein the triggering event is associated with a control signal for controlling the home device;
generate the control signal in response to the triggering event being detected; and
transmit the control signal to the home device through the network using the proprietary router through the path of communication in response to the triggering event being detected.

13. The system of claim 12, wherein the system further comprises:
a network device that uses a first communication and signaling protocol; and
a customer terminal that uses a second communication and signaling protocol different from the first communication and signaling protocol,
wherein the network device communicates with a network device management server using the first communication and signaling protocol,
wherein the customer terminal communicates with a network-based protocol translator adapted to convert the second communication and signaling protocol to a third communication and signaling protocol, and
wherein the network device management server is adapted to communicate using the third communication and signaling protocol.

14. The system of claim 13, wherein the mobile device communicates with the customer terminal via the network, and wherein the customer terminal forwards messages from the mobile device to the network device via the protocol translator and the network device.

15. The system of claim 12, wherein the system is further configured to:
transmit the control signal from the mobile device to the proprietary router over the network implemented over internet resources;
receive the control signal at the proprietary router and process the control signal to determine the known path of communication for the home device the control signal is configured to control;
route the control signal from the proprietary router using point-to-point communication through other devices on the network; and
receive the control signal at the home device.

16. The system of claim 12, wherein the system further comprises:
a customer terminal, wherein the home device is locally connected to the customer terminal;
wherein the system is further configured to:
transmit the control signal from the mobile device to the customer terminal through the proprietary router;
receive the control signal at the customer terminal for controlling the home device locally connected to the customer terminal; and
transmitting the control signal from the customer terminal to the home device.

17. The system of claim 12, wherein the system further comprises:
a home automation server (HAS), wherein the system is configured to:
transmit the control signal from the mobile device to the HAS through the proprietary router, wherein the HAS is configured for controlling the home device,
receive the control signal at the HAS, wherein the HAS is connected along the known communication path to the home device; and
transmit the control signal from the HAS to the home device.

18. The system of claim 12,
wherein the triggering event includes triggering event information that includes at least one selected from a group consisting of a user input, a geofence trigger signal, a scheduled instruction, a threshold sensor reading, and a third party request, and
wherein the home device is selected from a group consisting of a customer terminal, a thermostat, a mechanical servo device, a light switch, a video camera, a digital electronic device, a home appliance, a home audio device, a sensor array, and a security system sensor.

19. The system of claim 12, wherein generating the control signal at the mobile device includes:
deriving triggering event information from the triggering event;
processing the triggering event information;
processing control information received from one or more of a group consisting of a user input, a geofence trigger signal, a scheduled instruction, a threshold sensor reading, a third party request, and a stored data file associated with the independent home device that is to be controlled;
generating the control signal based on the triggering event information and control information.

20. The system of claim 12, further comprising:
a protocol translator communicatively connected to the proprietary router,
wherein transmitting the control signal from the mobile device to the home device through the network using the proprietary router by point-to-point communication through a known path of communication comprises:
using the protocol translator to take the control signal and translate the control signal into a format readable by other devices in the known path of communication and the home device.

21. A network-based protocol translator comprising:
A protocol converter adapted to convert first messages in a first protocol of a first group of communication protocols to messages in one or more second protocols in a second group of communication protocols,
wherein the first group of communication protocols include a source protocol, and
wherein the one or more second protocols include a destination protocol.

22. The network-based protocol translator of claim 21, further comprising:
a translation engine,
wherein the translation engine includes source protocol identification means adapted to identify the source protocol.

23. The network-based protocol translator of claim 21, further comprising:
a translation engine,
wherein the translation engine includes destination protocol identification means adapted to identify the destination protocol or protocols.

24. The network-based protocol translator of claim 22, wherein the translation engine includes destination protocol identification means adapted to identify the destination protocol or protocols.

25. A network-based protocol translator of claim 22, wherein the source protocol identification means includes an association between the source and the corresponding source protocol.

26. A network-based protocol translator of claim 23, wherein the destination protocol identification means includes an association between the destination and the corresponding destination protocol.
